(19) United States
(12) Patent Application Publication
(10) Pub. No.: US 2026/0340569 A1
(43) Pub. Date: Oct. 29, 2026

(54) ROUTE SEARCHING APPARATUS, ROUTE SEARCHING METHOD, AND PROGRAM

(71) Applicant: NTT, Inc., Tokyo (JP)

(72) Inventors: Kazuaki AKASHI, Musashino-shi, Tokyo (JP); Nobukazu FUKUDA, Musashino-shi, Tokyo (JP); Shunsuke KANAI, Musashino-shi, Tokyo (JP); Hiroaki MATSUBAYASHI, Musashino-shi, Tokyo (JP); Masataka SATO, Musashino-shi, Tokyo (JP); Mayu YAMAZOE, Musashino-shi, Tokyo (JP)

(21) Appl. No.: 19/110,122

(22) PCT Filed: Oct. 5, 2022
(86) PCT No.: PCT/JP2022/037263

§ 371 Date: Mar. 10, 2025

(51) Int. Cl. G06Q 10/083

(52) U.S. Cl. CPC G06Q 10/08355

(57) ABSTRACT

A route search device according to an aspect of the present invention searches for a movement route of a vehicle to a plurality of bases providing services to users using a solver. The route search device includes an acquisition unit, a planning problem formulation unit, and an input/output unit. The acquisition unit is configured to acquire a network topology of a network in which the plurality of bases are nodes, the number of users at each of the bases, and a movement time matrix between the bases. The planning problem formulation unit is configured to formulate a planning problem including an influence on the user as a constraint condition based on the network topology, the number of users, and the movement time matrix. The input/output unit is configured to output a solution obtained by delivering the formulated planning problem to the solver.

### TECHNICAL FIELD

An aspect of the present invention relates to a route search device, a route search method, and a program.

### BACKGROUND ART

In recent years, attention has been focused on delivery services which are responsible for logistics. Delivery of not only luggage such as parcels but also a power supply car in a disaster such as an earthquake or typhoon is one such delivery service. For example, when power is interrupted due to a disaster or the like, a communication service provider delivers a mobile power supply car to a building (communication building) to which a communication service is provided to restore power. Optimization of a visit route of the power supply car is also important to accelerate the restoration of the communication building.

A vehicle routing problem (VRP) is a problem of optimizing an order in which a plurality of vehicles are caused to visit a plurality of bases. The VRP is a combination optimization problem categorized into so-called NP-hard, and there are various studies on it. For example, optimization of a visit route to a demand point in a disaster can be examined as the VRP, and there are several reports.

### CITATION LIST

### Non Patent Literature

[NPL 1] Minami Ogawa et al., “A Proposal for a Delivery Planning Algorithm Considering the Importance of Points in a Disaster,” ICM Research Society, 2021
[NPL 2] Kazuaki Akashi et al., “A Study of Reinforcement Learning for Solving Multi-Vehicle Routing Problems” ICM Research Society, 2021
[NPL 3] M. Niu, R. Liu and H. Wang, “A Max-Min Ant System based on Decomposition for the Multi-Depot Cumulative Capacitated Vehicle Routing Problem,” 2021 IEEE Congress on Evolutionary Computation (CEC), 2021

### SUMMARY OF INVENTION

### Technical Problem

The known techniques have focused on only restoration of communication buildings in order to optimize patrol routes of vehicles. Although viewpoints are also important, there are no known techniques for going further by also taking the number of users using network services into account. That is, even if bases (communication buildings) can be efficiently restored and the bases used by many users are left, it would not be desirable from the viewpoints such as influences on users. There are demands for techniques capable of achieving both optimization of restoration of communication buildings and minimization of influences on users.

In view of the foregoing circumstances, the present invention provides a technique through which a patrol route capable of reducing an influence on users can be requested.

### Solution to Problem

According to an embodiment of the present invention, a route search device searches for a movement route of a vehicle to a plurality of bases providing services to users using a solver. The route search device includes an acquisition unit, a planning problem formulation unit, and an input/output unit. The acquisition unit is configured to acquire a network topology of a network in which the plurality of bases are nodes, the number of users at each of the bases, and a movement time matrix between the bases. The planning problem formulation unit is configured to formulate a planning problem including an influence on the users as a constraint condition based on the network topology, the number of users, and the movement time matrix. The input/output unit is configured to output a solution obtained by delivering the formulated planning problem to the solver.

### Advantageous Effects of Invention

According to an aspect of the present invention, it is possible to obtain a patrol route capable of reducing an influence on users.

### BRIEF DESCRIPTION OF DRAWINGS

FIG. 1 is a block diagram illustrating an example of a route search device according to an embodiment of the present invention.

FIG. 2 is a functional block diagram illustrating an example of a route search device 1 illustrated in FIG. 1.

FIG. 3 is a diagram illustrating an example of a flow of data in a system illustrated in FIG. 2.

FIG. 4 is a diagram illustrating route searching.

FIG. 5 is a diagram illustrating a problem setting according to an embodiment.

FIG. 6 is a diagram illustrating a combination of a network flow and a VRP.

FIG. 7 is a diagram illustrating the VRP.

FIG. 8 is a diagram illustrating a constraint condition related to movement.

FIG. 9 is a diagram illustrating an MTZ constraint.

FIG. 10 is a diagram illustrating constraints of an arrival time and a delay time.

FIG. 11 is a diagram illustrating an objective function of minimizing delay.

FIG. 12 is a diagram illustrating a definition of influence.

FIG. 13 is a diagram illustrating a flow constraint.

FIG. 14 is a diagram illustrating a relation between a visit and a flow.

FIG. 15 is a diagram illustrating a visit completion constraint formula.

FIG. 16 is a diagram illustrating an objective function of minimizing an influence.

FIG. 17 is a diagram illustrating an example of a network topology.

FIG. 18 is a diagram illustrating an example of the number of users in each city in the network of FIG. 17.

FIG. 19 is a graph illustrating a baseline for minimizing a delay time in accordance with a known scheme.

FIG. 20 is a graph illustrating an optimum route obtained in accordance with the scheme of an embodiment.

### DESCRIPTION OF EMBODIMENTS

Embodiments of the present invention will be described below with reference to the drawings.

### (Configuration)

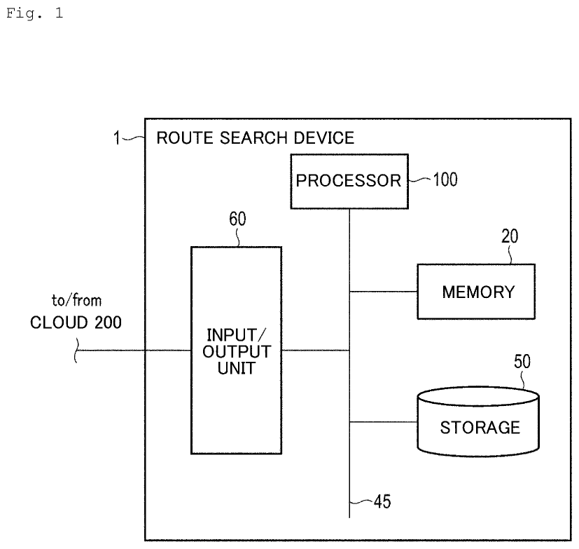

FIG. 1 is a block diagram illustrating an example of a route search device according to an embodiment of the present invention. The route search device 1 is a computer that includes a processor 100, a memory 20, a storage 50, and an input/output unit 60, and a bus 45 connecting them. The input/output unit 60 sets a communication link between the route search device 1 and a cloud 200, and transmits and receives various types of data.

The processor 100 is an arithmetic unit such as a central processing unit (CPU) or a micro processing unit (MPU), and implements processing functions according to an embodiment in accordance with a program loaded from the storage 50 to the memory 20.

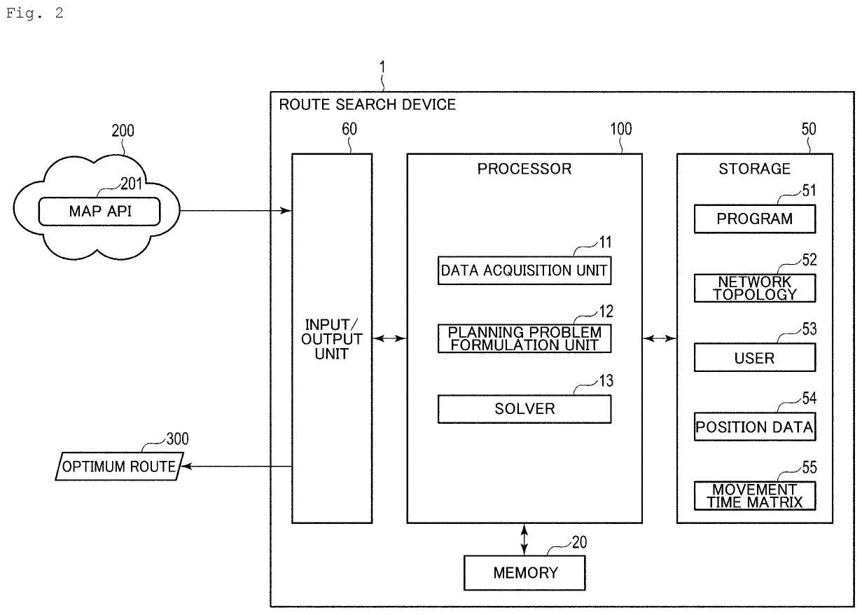

FIG. 2 is a functional block diagram illustrating an example of the route search device 1 illustrated in FIG. 1. In FIG. 2, the memory 20 is a semiconductor memory such as a read only memory (ROM) or a random access memory (RAM).

The storage 50 is a nonvolatile memory such as a hard disk drive (HDD) or a solid state drive (SSD) and stores a program 51 implementing processing according to the embodiment in addition to basic software such as an operating system (OS). That is, the program 51 can be installed on the route search device 1.

The storage 50 includes an area for storing a network topology 52 of a network which is a route searching target, an area for storing the number of users 53, an area for storing position data 54, and an area for storing a movement time matrix 55. 1 can be installed on the route search device 1.

The network topology 52 is data representing a topology of a network which is a route searching target. In the embodiment, a plurality of bases which are a vehicle delivering target are referred to as nodes, and the inter-nodes are referred to as arcs.

The number of users 53 is the number of users at each base (node). That is, the number of users is the number of users who use a network service at each base.

The position data 54 is a position of each base represented by, for example, latitude and longitude.

The movement time matrix 55 is data indicating a movement time between bases in a matrix format.

The processor 100 includes a data acquisition unit 11, a planning problem formulation unit 12, and a solver 13 as processing functions according to an embodiment of the present invention.

The data acquisition unit 11, the planning problem formulation unit 12, and the solver 13 are implemented by the processor 100 executing programs loaded in the memory 20. That is, the program 51 includes a command for causing the processor 100 to function as the data acquisition unit 11, a command for causing the processor 100 to function as the planning problem formulation unit 12, and a command for causing the processor 100 to function as the solver 13.

The data acquisition unit 11 stores input data in the storage 50. That is, the data acquisition unit 11 stores the network topology 52, the number of users 53, the position data 54, and the movement time matrix 55 in the storage 50. Here, the data acquisition unit 11 delivers the position data 54 to a map application programming interface (API) 201 of the cloud 200, acquires a movement time matrix 55 returned in response to the map API, and stores the movement time matrix 55 in the storage 50. The map API 201 is a service provided by the cloud 200.

The planning problem formulation unit 12 formulates a planning problem including an influence on users as a constraint condition based on the network topology 52 of the storage 50, the number of users 53, and the movement time matrix 55.

The constraint condition is, for example, a condition that an influence on users is minimized by an interruption of a service at each base. The constraint condition further includes a condition satisfying a network flow of a network represented by the network topology 52.

The solver 13 derives a solution to the planning problem delivered from the planning problem formulation unit 12. This solution is an optimized delivery route and is output as an optimum route 300 from the input/output unit 60. The delivery route obtained here becomes a patrol route for patrolling each of the plurality of bases in a single stroke under the constraint condition.

The input/output unit 60 outputs the selected optimum route 300.

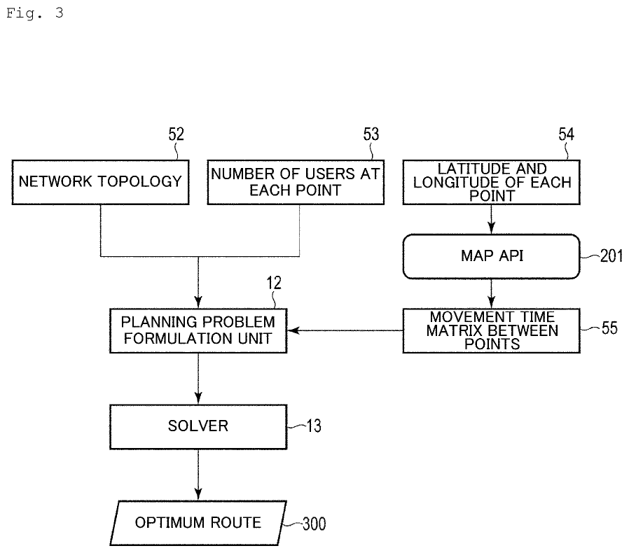

FIG. 3 is a diagram illustrating an example of a flow of data in the system illustrated in FIG. 2. In FIG. 3, the network topology 52 and the number of users 53 at each point are given to the planning problem formulation unit 12 of the route search device 1. On the other hand, the route search device 1 transmits a request including the position data 54 of each point represented by latitude and longitude to the map API 201. Then, the map API 201 returns a response including the movement time matrix of each point to the route search device 1. The movement time matrix is given to the planning problem formulation unit 12.

The planning problem formulation unit 12 formulates a planning problem including an influence on users as a constraint condition based on the network topology 52, the number of users 53 at each point, and the movement time matrix 55 and delivers the planning problem to the solver 13. The solver 13 is, for example, a solver specialized in obtaining of a solution to a combination optimization problem, and obtains a solution (optimal route 300) to the delivered planning problem.

### Operational Effects

Next, operational effects of the above configuration will be described.

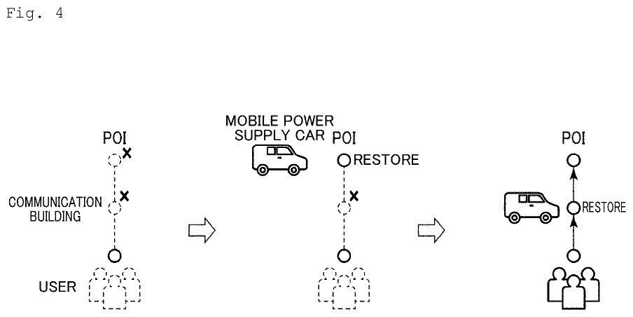

FIG. 4 is a diagram illustrating route searching. In FIG. 4, if a failure occurs in a communication building that provides users with an access service to a point of interface (POI) serving as a connection base to an internet service provider (ISP), none the users who are connected to the communication building can receive the service. Accordingly, a mobile power supply car (vehicle) is moved (circulated) to each point to achieve restoration. When the communication building is restored, the users can receive the provision of the communication service again. In FIG. 4, since a target is general, the communication building can be interpreted as a communication facility, and the mobile power supply car can be interpreted as a worker.

In a known technique that is mindful of occurrence of a disaster, the number of users connected to a network is not taken into account. Therefore, a patrol route for minimizing an influence on the users cannot be searched for. Thus, according to an embodiment, a technique for calculating a patrol route capable of minimizing an influence on users will be disclosed.

### <Problem Setting>

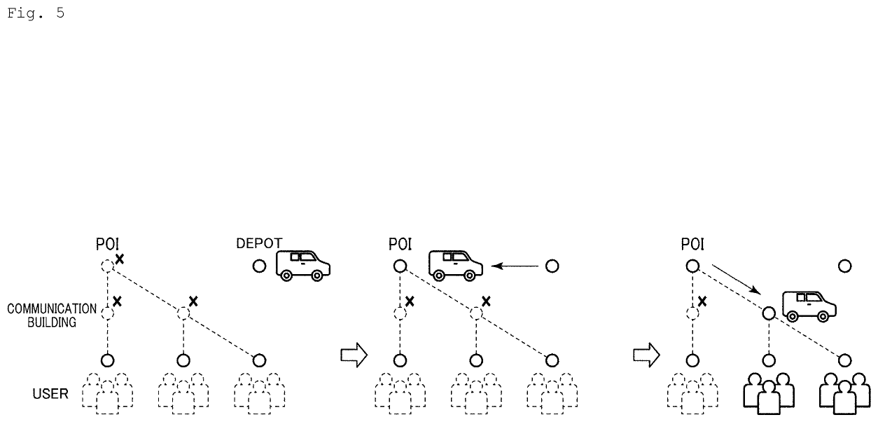

FIG. 5 is a diagram illustrating a problem setting according to an embodiment. In an embodiment, it is conceivable that when a network service stops during occurrence of a disaster, a communication facility is restored by patrolling a communication building, and the network service is restored. Accordingly, in the embodiment, the following initial conditions are set to optimize a patrol route of a vehicle.
The vehicle moves between a departure point (depot) and the communication building.
At the departure point of the movement, all the communication buildings are disconnected. Thus, the vehicle visits the communication buildings, and the communication buildings are restored.
The users for whom all the communication buildings on the communication path to the POI have recovered can resume communication.
The number of users who cannot communicate with each other is minimized.

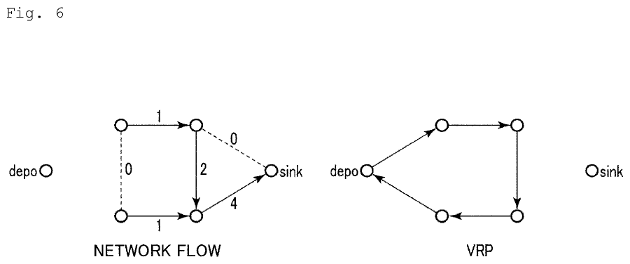

FIG. 6 is a diagram illustrating a combination of a network flow and a VRP. In FIG. 6, the network flow is represented by a flow network including a plurality of nodes including a start point (depo) and an end point (sink), and arcs connecting the nodes. Each arc defines a flow rate (for example, 0, 1, 2, or 4). In the embodiment, it is conceivable that the VRP in the network flow is solved. That is, in the embodiment, a user influence of a network is calculated by using the network flow. Accordingly, it is possible to formulate the user influence and incorporate the user influence into an optimization problem.

In the embodiment, a visit of a vehicle (car) and communication on the network are formulated as one planning problem. Accordingly, it is possible to optimize the patrol route for minimizing the user influence.

Further, in the embodiment, the formulated problem is converted into a mixed integer linear plan and input to a solver. Accordingly, it is possible to obtain an optimum solution using a known solver.

When the VRP and the flow are simultaneously optimized, a sum of the number of users who cannot receive a service (cannot connect) at each time is defined as an influence. A unit of the influence is equal to (time×the number of users). In the embodiment, a patrol route is derived by optimizing an objective function of minimizing the influence.

Further, the following amounts are introduced in the embodiment.

### [Math. 1]

Sourceᵢ∈ [symbol] : a source amount to the number of users at i
sink: a sink of a flow to a point of Interface to ISP
n(i): a set of points connected to i and the network

### <VRP>

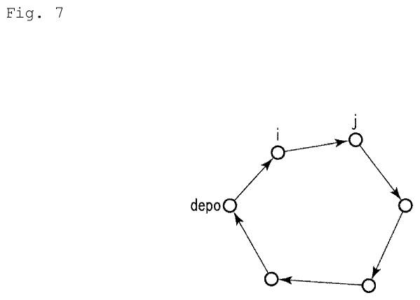

FIG. 7 is a diagram illustrating the VRP. In the VRP, a patrol route for visiting each point (base) only once is searched for. That is, a solution for minimizing a delay time at each point is searched for using the following various amounts.

### [Math. 2]

Distanceᵢⱼ∈ [symbol] ₊: a distance between i and j to a movement time
Depo: a point at which a car starts and arrives
V′: a set of a visit destination of a car except for depo

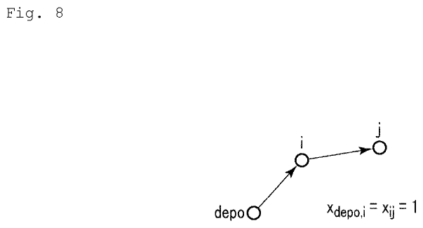

FIG. 8 is a diagram illustrating a constraint condition related to movement. Constraint conditions related to the movement are represented by the following items.

### [Math. 3]

x_{i,j}: x_{i,j}=1 at the time of movement from i to j
a visit from i and a visit to j are done just once
for depo, a visit from depo and
   a visit to depo are made just once

Based on the items, Formulae (1) and (2) are obtained in accordance with a travelling salesman problem (TSP).

$$\begin{matrix}[ Math . 4 ] & \\ {x}_{ij} ∈ \{ 0 , 1 \} ( i , j ∈ {V}^{′} + \{ depo \} , i \neq j ) & ( 1 )\end{matrix}$$

$$\begin{matrix}\underbrace{{\sum }_{j ∈ {V}^{′} + \{ depo \} , i \neq j} {x}_{i j}}_{visit from i} = \underbrace{{\sum }_{j ∈ {V}^{′} + \{ depo \} , i \neq j} {x}_{ji}}_{visit to j} = 1 ( i ∈ {V}^{′} + \{ depo \} ) & ( 2 )\end{matrix}$$

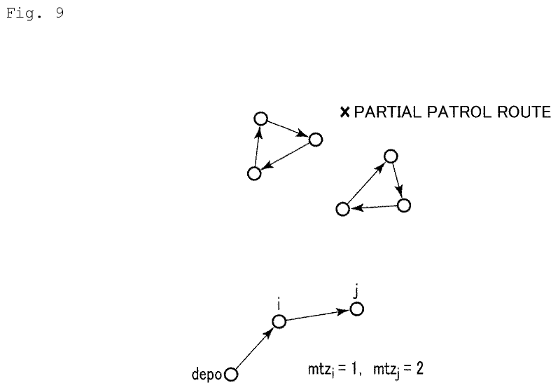

FIG. 9 is a diagram illustrating an MTZ constraint. The MTZ constraint is a constraint condition that a partial patrol route illustrated in FIG. 9 is removed. Here, when an order of a visit to a point i is expressed as mtzᵢ, Formulae (3) and (4) are obtained.

### [Math. 5],

mtzᵢ∈[1,|V′+{depo}|−1](i∈V′) (3)

mtzᵢ−mtzⱼ+1+|V′+depo|·(xᵢⱼ−1)≤0(i,j∈V′,i≠j) (4)

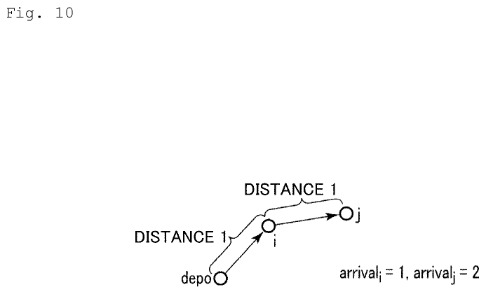

FIG. 10 is a diagram illustrating constraints of an arrival time and a delay time. A relation among an arrival time, a delay time, and the indexes i and j is shown below.

### [Math. 6]

arrivalᵢ: an arrival time to i
delayᵢ: a delay time at i
when movement from i to j is made.
   an arrival time to i+i→movement time of i→j≤an arrival time to j
the arrival time is defined as a delay time

By using the various amounts, Formulae (5), (6) and (7) are obtained by using M as a sufficiently large number.

### [Math. 7],

arrivalᵢ,delayᵢ∈ [symbol] ₊(i∈V′) (5)

arrivalᵢ≤delayᵢ(i∈V′) (6)

arrivalᵢ+Distanceᵢⱼ≤arrivalⱼ+M·(1−xᵢⱼ)(i∈V′+{depo},j∈V′,i≠j) (7)

The second term on the left side in Formula (7) represents a movement time of i→j. Formula (7) is always established if xᵢⱼ=0.

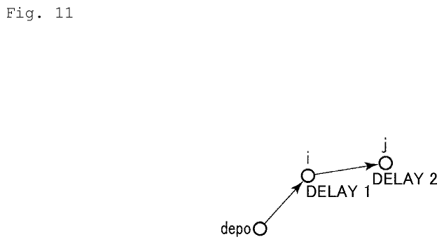

FIG. 11 is a diagram illustrating an objective function of minimizing delay. The objective function for minimizing a delay time at each point is expressed by Formula (8).

$$\begin{matrix}[ Math . 8 ] & \\ min {\sum }_{i ∈ {V}^{′}} {delay}_{i} & ( 8 )\end{matrix}$$

In Formula 8, delayᵢ represents a delay time at each point.

### <Network Flow>

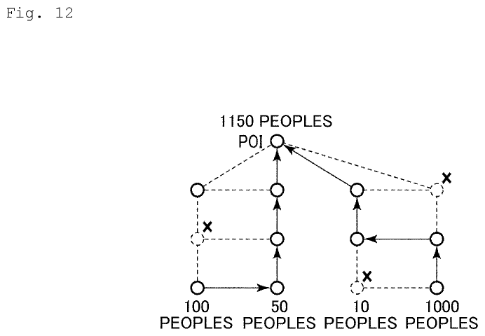

FIG. 12 is a diagram illustrating definition of an influence. In the network illustrated in FIG. 12, the number of users who cannot be connected to the POI (=sink) is counted. At each time, a total sum of the number of users who cannot be connected is added to set an influence. The influence is expressed by Formula (9).

### [Math. 9]

the number of users who cannot be connected to POI (=sink) is counted
the number of users who cannot be connected at each time is added to set an influence

Influence=Σₜ number of users (t) that cannot be connected (9)

For example, in the network flow illustrated in FIG. 12, when a failure occurs in all the communication buildings, four people cannot be connected to a communication service. In the embodiment, a route for minimizing the influence is searched for by establishing a formula for simultaneously considering a (VRP constraint) and a (flow constraint). For the (VRP constraint), the visit constraint of Formulae (1) and (2) and the MTZ constraint of formulae (3) and (4) can be applied.

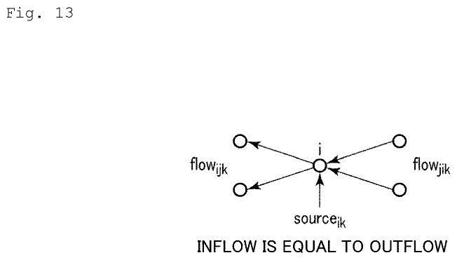

FIG. 13 is a diagram illustrating a flow constraint. For (flow constraint), the following items are set.

### [Math. 10]

flowᵢⱼₖ∈ [symbol] ₊: a flow from i to j
   immediately before a car arrives at k
sourceᵢₖ∈{0,1}: a source from i immediately before a car arrives at k

For sourceᵢₖ, the number of connected users is calculated by multiplying Sourceᵢ.

$$\begin{matrix}[ Math . 11 ] & \\ \underbrace{{\sum }_{j ∈ n ( i )} {flow}_{ijk}}_{outflow from i} = \underbrace{{\sum }_{j ∈ n ( i )} {flow}_{j i k}}_{inflow from i} + {source}_{i k} ( i , k ∈ {V}^{′} ) & ( 10 )\end{matrix}$$

The left side of Formula (10) indicates an outflow from a node i, the first term of the right side indicates an inflow to the node i, and the second term indicates the outflow from the node i. As illustrated in FIG. 13, Formula (13) is established on the assumption that the inflow is equal to the outflow.

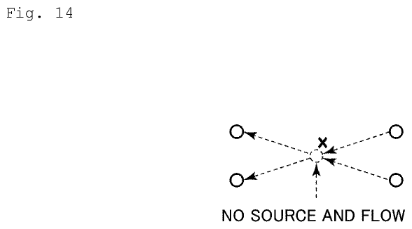

FIG. 14 is a diagram illustrating a relation between a visit and a flow. The following items are established by associating the visit with the network flow.

### [Math. 12]

There is no source or flow at the node before the car visits
   visitedᵢₖ: visit to i was made immediately before the visit to k.
   if the visit to i is not made, outflow from i=0

Formula (11) is established based on the above items by using the fact that there is no source or flow in an intermediate node as a constraint condition.

$$\begin{matrix}[ Math . 13 ] & \\ {visited}_{ij} ( i , j ∈ {V}^{′} , i \neq j ) \underbrace{{\sum }_{j ∈ n ( i )} {flow}_{ijk}}_{outflow from i} \leq \underbrace{M \cdot {visited}_{i k}}_{always established If {visited}_{ik} = 1} ( i , k ∈ {V}^{′} ) & ( 11 )\end{matrix}$$

The left side of Formula (11) indicates the outflow from the node i and Formula (11) is a term always established if visitedᵢₖ=1.

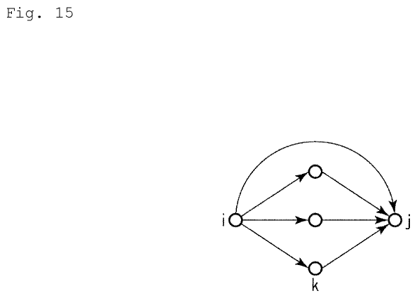

FIG. 15 is a diagram illustrating a visit completion constraint formula. The following items indicate that the visited node is not visited again.

### [Math. 14],

a visit to i is completed immediately before arrival at j.
   =movement from i to j
      +moved from the visited i to j via k.
since a product of the optimized variables is not a linear function, the product is converted into a linear formula

The foregoing items can be solved as a mixed integer linear plan. Accordingly, Formulae (12) and (13) to (16) can be derived.

$$\begin{matrix}[ Math . 15 ] & \\ {visited}_{ij} = {x}_{i j} + {\sum }_{k ∈ V ' - \{ i , j \}} {visited}_{i k} \cdot {x}_{k j} ( i , j ∈ {V}^{′} , i \neq k \neq j ) & ( 12 )\end{matrix}$$

$$\begin{matrix}[ Math . 16 ] & \\ {visited\_x}_{i k j} = {visited}_{ik} \cdot {x}_{k j} & ( 13 )\end{matrix}$$

$${visited\_x}_{i k j} \leq {visited}_{i k} \qquad ( 14 )$$

$${visited\_x}_{i k j} \leq {x}_{k j} \qquad ( 15 )$$

$${visited\_x}_{i k j} \geq {visited}_{i k} + {x}_{k j} - 1 \qquad ( 16 )$$

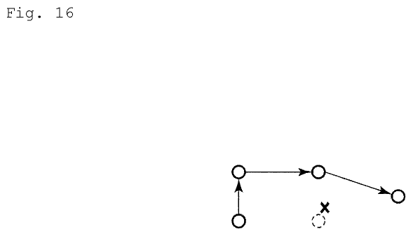

FIG. 16 is a diagram illustrating an objective function of minimizing an influence. The influence is a total sum of the number of users who cannot be connected at each time, and a patrol route capable of minimizing the total sum is searched for. For example, as shown in Formula (17), all the patrol routes can be compared to search for a patrol route in which the influence can be minimized.

$$\begin{matrix}[ Math . 17 ] & \\ min {\sum }_{j ∈ {V}^{′}} ( {\sum }_{k ∈ {V}^{′}} {Source}_{k} \cdot ( 1 \to {source}_{k j} ) ) \cdot ( {\sum }_{i ∈ {V}^{′} + \{ d e p o \} , i \neq j} {Distance}_{i j} \cdot {x}_{ij} ) = {\sum }_{i ∈ {V}^{′} + \{ d e p o \} , j , k ∈ {V}^{′} , i \neq j} {Source}_{k} \cdot {Distance}_{i j} \cdot ( 1 - {source}_{k j} ) \cdot {x}_{ij} & ( 17 )\end{matrix}$$

In Formula (17), the total sum of the product of the number of users who cannot be connected and a time at which the users cannot be connected on the left side is transformed into the right side. The product (1−sourceₖⱼ)·xᵢⱼ of the optimization variable of the right side is linearly converted like Formulae (12) to (16).

### Applied Examples

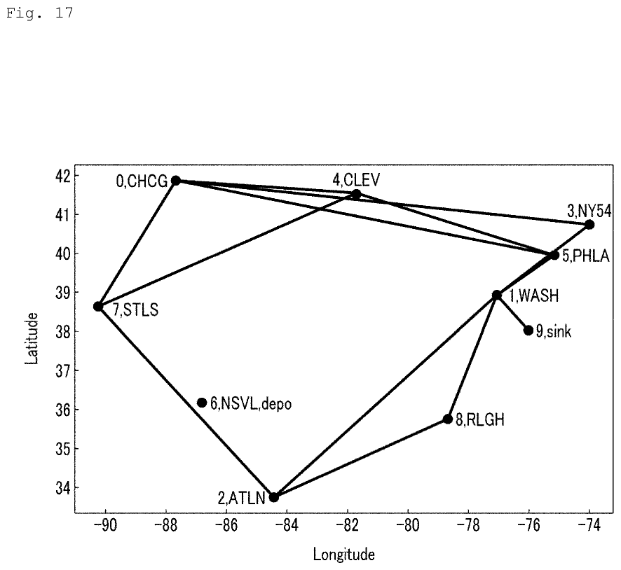

Next, an example in which the scheme according to the embodiment is applied to an actual network will be described. FIG. 17 is a diagram illustrating an example of a network flow. Here, an IP/MPLS backbone in the United States east part of an existing network service provider disclosed in the website <http://www.topology-zoo.org/> of The Internet Topology Zoo will be selected and described as an example.

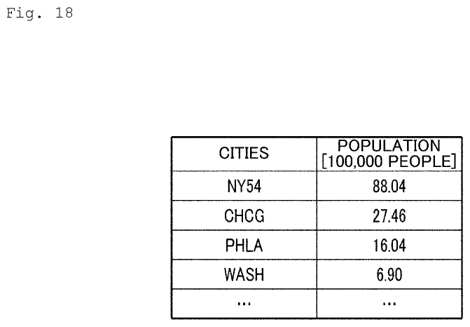

In FIG. 17, 6,NSVL is set in depo. Further, sink is set separately from each city, and 1, WASH is connected to 9, sink. As illustrated in FIG. 18, it is assumed that the number of users in each city is the population of each city in 2020. Further, it is assumed that a movement time between the cities is defined as a movement time between the points. The conditions were formulated in MIP and an optimization simulation was performed by python-mip.

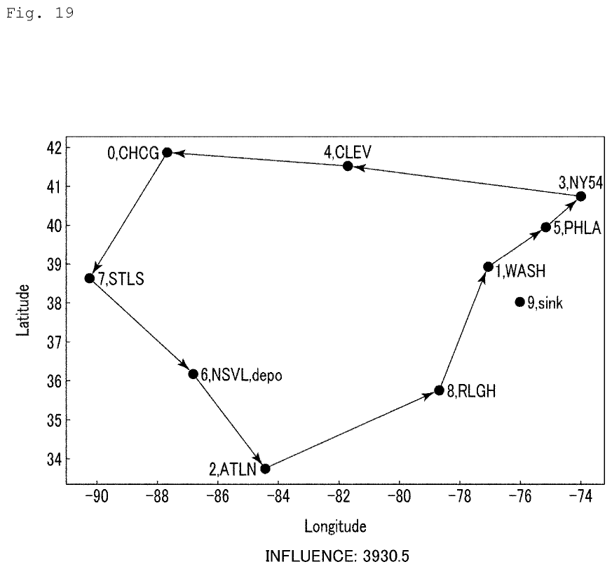

FIG. 19 is a graph illustrating a baseline for minimizing a delay time in accordance with a known scheme. That is, reference numeral 19 denotes a route optimized in consideration of only the VRP.

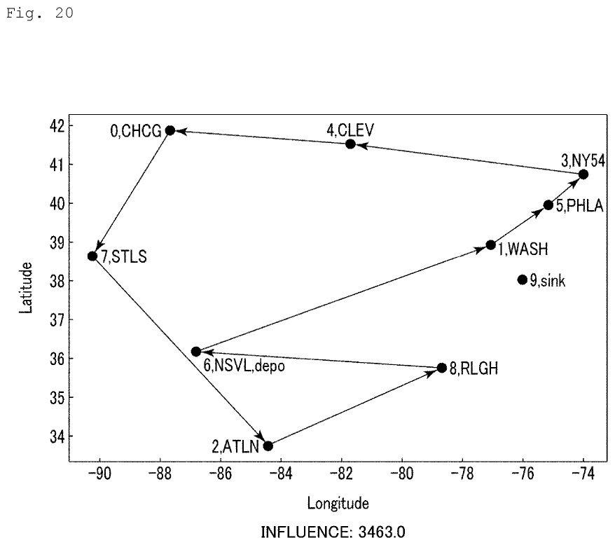

FIG. 20 is a graph illustrating an optimum route obtained in accordance with the scheme of an embodiment. While the influence in FIG. 19 was 3930.5 the influence in FIG. 20 was 3463.0. That is, according to the embodiment, it was shown that a patrol route in which the influence on the user can be reduced further compared to the existing technique can be derived.

In FIG. 20, it can be understood that (1,WASH) in which the number of users is relatively large and which is connected to the sink is prioritized. This result relates to the fact that the number of users of WASH is the fourth largest, WASH is connected to a sink (POI), and is located above in a topology. A unit of the influence is expressed by [100,000 people×1 hour].

As described above, in the embodiment, the user influence of the network is used as a new parameter by using the network flow in addition to the VRP when the patrol route of the vehicle is optimized. That is, a patrol route for minimizing the user influence is obtained by formulating the user influence using the network flow and solving the planning problem combined with the route search.

In the known technique, it is not considered to minimize the number of users who cannot use the network service because it is considered to minimize the movement time or the like when the patrol route of the communication building is examined. In other words, although a report in which the transport problem is studied in relation to the VRP is known, a study in which the transport problem is optimized in consideration of the network flow together with the patrol route is not reported.

On the other hand, in the embodiment, the number of users who cannot use the network service is calculated at each unit time until a repair of the communication facility is all completed by patrolling the communication building, and a patrol route for minimizing the total number is calculated. Accordingly, it is possible to minimize the influence on the user until the network service is restored.

That is, in the embodiment, the influence on the user of the network is calculated using the network flow. Accordingly, it is possible to formulate and incorporate the user influence into the optimization problem.

In the embodiment, a visit of the vehicle and communication on the network are formulated as one planning problem. Accordingly, it is possible to optimize the patrol route for minimizing the user influence.

Further, in the embodiment, the formulated problem was converted into a mixed integer linear plan. Accordingly, it is possible to obtain an optimum solution using an existing solver.

Thus, according to the embodiment, it is possible to obtain a patrol route in which the influence on the user can be reduced.

The present invention is not limited to the above-described embodiments. For example, in the embodiment, the route search device 1 includes the solver 13, as described above. Alternatively, the solver 13 can, of course, be mounted on a server computer separate from the route search device 1. In this form, the route search device 1 transfers the planning problem generated by the planning problem formulation unit 12 from the input/output unit 60 to the server computer and receives a solution.

Alternatively, the solver 13 may be mounted as a service of the cloud 200. In this case, the solver is positioned similarly to the map API when viewed from the route search device 1. Alternatively, a solver can be realized as a platform as a service (PaaS).

That is, the present invention is not limited to the above-described embodiments. At an implementation stage, the constituent elements can be modified in various forms without departing from the spirit of the invention. Also, various inventions can be formed by suitably combining a plurality of constituent components disclosed in the above-described embodiments. For example, some constituent elements may be omitted from all of the constituent elements in the embodiments. Further, constituent elements from different embodiments may be combined as appropriate.

### REFERENCE SIGNS LIST

1 Route search device
11 Data acquisition unit
12 Planning problem formulation unit
13 Solver
20 Memory
45 Bus
50 Storage
51 Program
52 Network topology
54 Position data
55 Movement time matrix
60 Input/output unit
100 Processor
200 Cloud
300 Optimum route

1. A route search device configured to search for a movement route of a vehicle to a plurality of bases providing services to users using a solver, the route search device comprising:
an acquisition unit, comprising one or more processors, configured to acquire a network topology of a network in which the plurality of bases are nodes, the number of users at each of the bases, and a movement time matrix between the bases;
a planning problem formulation unit, comprising one or more processors, configured to formulate a planning problem including an influence on the users as a constraint condition based on the network topology, the number of users, and the movement time matrix; and
an input/output unit configured to output a solution obtained by delivering the formulated planning problem to the solver.

2. The route search device according to claim 1, wherein the constraint condition includes a condition for minimizing an influence on the users due to an interruption of the service at each of the bases.

3. The route search device according to claim 2, wherein the constraint condition further includes a condition satisfying a network flow of the network topology.

4. The route search device according to claim 1, wherein the acquisition unit is configured to acquire the movement time matrix from a cloud providing a map application programming interface (API).

5. The route search device according to claim 1, wherein the movement route is a patrol route for patrolling each of the plurality of bases in a single stroke.

6. A route search method of searching for a movement route of a vehicle to a plurality of bases providing services to users using a computer and a solver, the method comprising:
acquiring a network topology of a network having the plurality of bases as nodes, the number of users for each of the bases, and a movement time matrix between the bases;
formulating a planning problem including an influence on the users as a constraint condition based on the network topology, the number of users, and the movement time matrix; and
outputting a solution obtained by giving the formulated planning problem to the solver.

7. A non-transitory computer readable medium storing a program, wherein execution of the program causes a computer to function as the route search device according to claim 1.
